(19) United States
(12) Patent Application Publication
(10) Pub. No.: US 2025/0084676 A1
(43) Pub. Date: Mar. 13, 2025

(54) Door Handle Assembly

(71) Applicant: Illinois Tool Works Inc., Glenview, IL (US)

(72) Inventor: Gang YU, Shanghai (CN)

(21) Appl. No.: 18/882,929

(22) Filed: Sep. 12, 2024

(30) Foreign Application Priority Data
Sep. 13, 2023 (CN) 202311187654.5
Aug. 21, 2024 (CN) 202411156358.3

(51) Int. Cl. E05B 85/10

(52) U.S. Cl. CPC E05B 85/107; E05B 85/103

(57) ABSTRACT

The present disclosure discloses a door handle assembly. The door handle assembly includes a base, a handle, a transmission assembly, and a door lock lever driving component. The base defines a receiving space. The handle is arranged in the receiving space and movable relative to the base. The transmission assembly is rotatable relative to the base. The door lock lever driving component is connected to the transmission assembly and has a locked position and an unlocked position, and the door lock lever driving component is movable relative to the base between the locked position and the unlocked position. A movement of the handle relative to the base is capable of driving rotation of the transmission assembly relative to the base, to drive the door lock lever driving component to move from the locked position to the unlocked position. The door handle assembly of the present disclosure is suitable for a door lock lever made of a hard material (e.g., metal, or plastic), has a simple structure and a stable movement, and can drive the door lock lever driving component to move between the locked position and the unlocked position, thereby enabling locking and unlocking of a door lock.

### RELATED APPLICATIONS

The present application claims the benefit of Chinese Patent Application Nos. 202311187654.5, filed Sep. 13, 2023, and 202411156358.3, filed Aug. 21, 2024, each titled “Door Handle Assembly,” the contents of which are hereby incorporated by reference.

### BACKGROUND

The present disclosure relates to a door handle assembly. A door handle assembly includes a handle and a door lock cable. The door lock cable can be pulled by the handle. However, the door lock cable is made of a flexible material, such as a rope. Its direction of movement is variable.

### SUMMARY

The present disclosure relates generally to a door handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a door handle assembly of the present disclosure, with a handle in a hidden position.

FIG. 1B is a partially exploded view of the door handle assembly of the present disclosure, with the handle in the hidden position.

FIG. 2A is a front view of the door handle assembly of FIG. 1A, with the handle in an extended position.

FIG. 2B is a partially exploded front view of the door handle assembly shown in FIG. 1A, with the handle in the extended position.

FIG. 3A is a front view of the door handle assembly shown in FIG. 1A, with the handle in a pulled position.

FIG. 3B is a partially exploded front view of the door handle assembly shown in FIG. 1A, with the handle in the pulled position.

FIGS. 4A-4B are perspective views from different directions of a first aspect of a transmission assembly and a door lock lever driving component.

FIG. 5 is an exploded view of the first aspect of the transmission assembly and the door lock lever driving component shown in FIGS. 4A-4B.

FIG. 6A is a perspective view of an insertion member shown in FIG. 5.

FIG. 6B is a side view of the insertion member shown in FIG. 6A.

FIG. 7 is a perspective view of a second rotating component shown in FIG. 5.

FIG. 8A is a perspective view showing the assembly of the insertion member and an abutment member.

FIG. 8B is a front view showing the assembly of the insertion member and the abutment member.

FIG. 9 is a perspective view of a second aspect of the transmission assembly 108 of the present disclosure.

FIG. 10A is a front view of the transmission assembly as shown in FIG. 9, a second arm of the handle, the abutment member, and the door lock lever driving component, with the handle in the hidden position and the door lock lever driving component in a locked position.

FIG. 10B is a side view of the transmission assembly as shown in FIG. 9, the second arm of the handle, the abutment member, and the door lock lever driving component, with the handle in the hidden position and the door lock lever driving component in the locked position.

FIG. 11A is a front view of the transmission assembly as shown in FIG. 9, a second arm of the handle, the abutment member, and the door lock lever driving component, with the handle in the extended position and the door lock lever driving component in the locked position.

FIG. 11B is a side view of the transmission assembly as shown in FIG. 9, a second arm of the handle, the abutment member, and the door lock lever driving component, with the handle in the extended position and the door lock lever driving component in the locked position.

FIG. 12A is a front view of the transmission assembly as shown in FIG. 9, a second arm of the handle, the abutment member, and the door lock lever driving component, with the handle in the pulled position and the door lock lever driving component in an unlocked position.

FIG. 12B is a side view of the transmission assembly as shown in FIG. 9, the second arm of the handle, the abutment member, and the door lock lever driving component, with the handle in the pulled position and the door lock lever driving component in an unlocked position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a door handle assembly. The door handle assembly includes a base, a handle, a transmission assembly, and a door lock lever driving component. The base defines a receiving space. The handle is arranged in the receiving space and movable relative to the base. The transmission assembly is rotatable relative to the base. The door lock lever driving component is connected to the transmission assembly and has a locked position and an unlocked position, and the door lock lever driving component is movable relative to the base between the locked position and the unlocked position. A movement of the handle relative to the base is capable of driving the transmission assembly to rotate relative to the base, to drive the door lock lever driving component to move from the locked position to the unlocked position.

According to the door handle assembly described above, the handle has an extended position and a pulled position and is movable between the extended position and the pulled position. The movement of the handle from the extended position to the pulled position is capable of driving the transmission assembly to rotate, to drive the door lock lever driving component to move from the locked position to the unlocked position.

According to the door handle assembly described above, the handle further has a hidden position and is movable between the hidden position and the extended position. During a movement of the handle from the hidden position to the extended position, the handle is separated from the transmission assembly such that the movement of the handle does not drive the door lock lever driving component to move.

According to the door handle assembly described above, the transmission assembly includes a first rotating assembly and a second rotating component. The first rotating assembly is capable of rotatable about a first axis relative to the base. The second rotating component is rotatable about a second axis relative to the base, and the door lock lever driving component being rotatably connected to the second rotating component. The handle is capable of driving the first rotating assembly to rotate, and the first rotating assembly is capable of driving the second rotating component to rotate.

According to the door handle assembly described above, the first axis is substantially perpendicular to the second axis.

According to the door handle assembly described above, the door lock lever driving component is rotatable about a third axis relative to the second rotating component to move relative to the base. The second axis and the third axis are arranged parallel to each other and offset by a distance.

According to the above door handle assembly, the handle is provided with a driving aperture, the first rotating assembly includes a transmission arm, and at least a part of the transmission arm is received in the driving aperture. The transmission arm is separated from a wall of the driving aperture during the movement of the handle from the hidden position to the extended position, and the handle drives the transmission arm during the movement of the handle from the extended position to the pulled position.

According to the door handle assembly described above, the handle further includes a first arm, a second arm, and a handle body. The first arm is rotatably connected to the base. The second arm is rotatably connected to the base. The handle body is rotatably connected to the first arm and the second arm. The second arm is provided with a driving aperture. During the movement of the handle from the extended position to the pulled position, the transmission arm abuts against the second arm, to drive the transmission arm.

According to the door handle assembly described above, the first rotating assembly is provided with a guide recess, and the second rotating component is provided with a guide protrusion, wherein the guide protrusion is capable of being at least partially received in the guide recess. The guide recess and the guide protrusion are configured such that rotation of the first rotating assembly about the first axis is capable of driving the second rotating component to rotate about the second axis.

According to the door handle assembly described above, the guide recess is arranged about the first axis and is recessed inwardly from an outer surface of the first rotating assembly. The guide protrusion is formed by extending a distance along the second axis.

According to the door handle assembly described above, the door handle assembly further includes an abutment member, wherein the abutment member is arranged on the base, and the first rotating assembly is provided with a limiting portion. The limiting portion is configured such that when the handle is in the hidden position, the abutment member abuts against the first rotating assembly such that the handle is maintained in the hidden position after being moved from the extended position to the hidden position.

According to the door handle assembly described above, the abutment member is made of a flexible material.

According to the door handle assembly described above, the first rotating assembly is provided with a first gear, the second rotating component is provided with a second gear, and the first gear and the second gear mesh with each other such that rotation of the first rotating assembly about the first axis is capable of driving the second rotating component to rotate about the second axis.

According to the door handle assembly described above, the door handle assembly further includes a transmission return assembly configured to rotate the transmission assembly during a movement of the handle from the pulled position to the extended position, to drive the door lock lever driving component to move from the unlocked position to the locked position.

According to the above door handle assembly, the transmission return assembly includes a first elastic member and a second elastic member. The first elastic member is configured to apply a force on the first rotating assembly such that the first rotating assembly rotates about the first axis. The second elastic member is configured to apply a force on the second rotating component such that the second rotating component rotates about the second axis.

According to the above door handle assembly, the door handle assembly further includes a handle return component, the handle return component being configured to apply a force on the handle, to move the handle from the pulled position to the extended position.

The door handle assembly of the present disclosure has a simple structure and a invariable movement direction, and can drive the door lock lever driving component to move between the locked position and the unlocked position, thereby enabling locking and unlocking of a door lock.

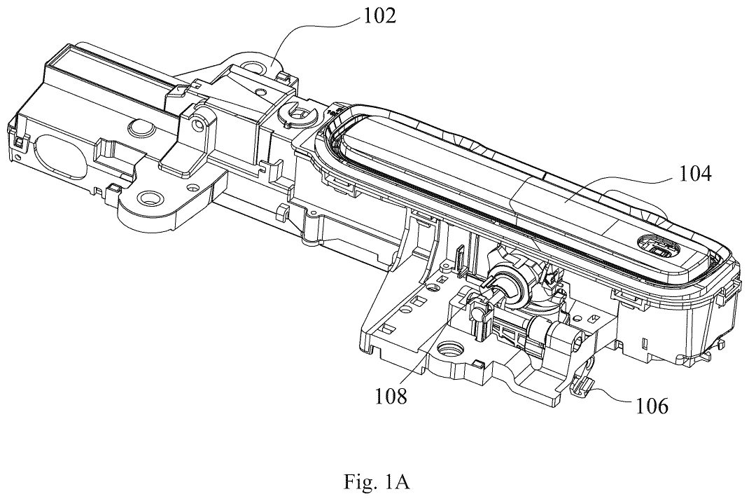

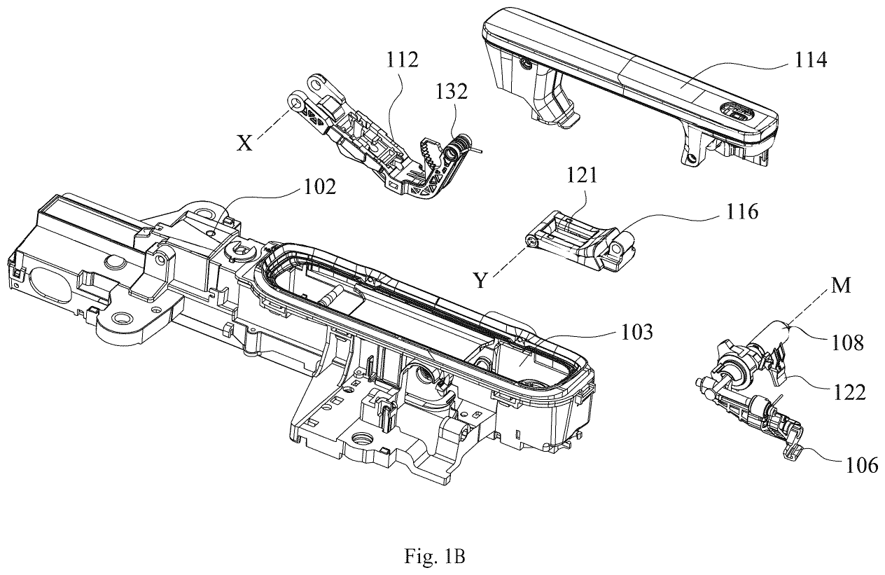

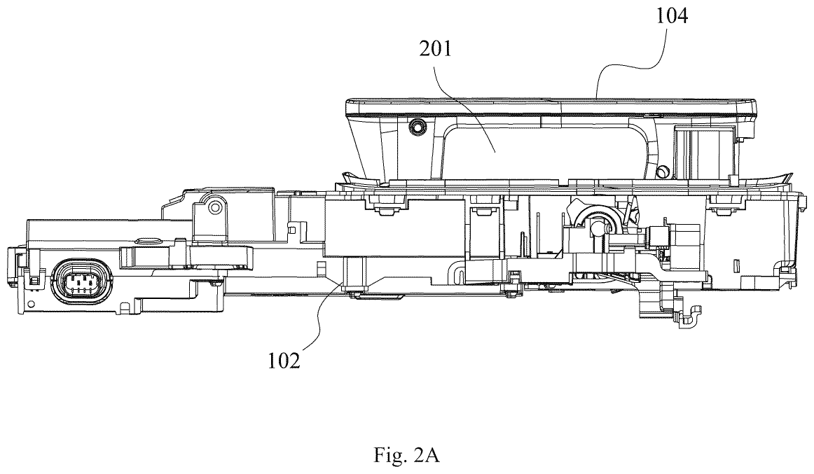

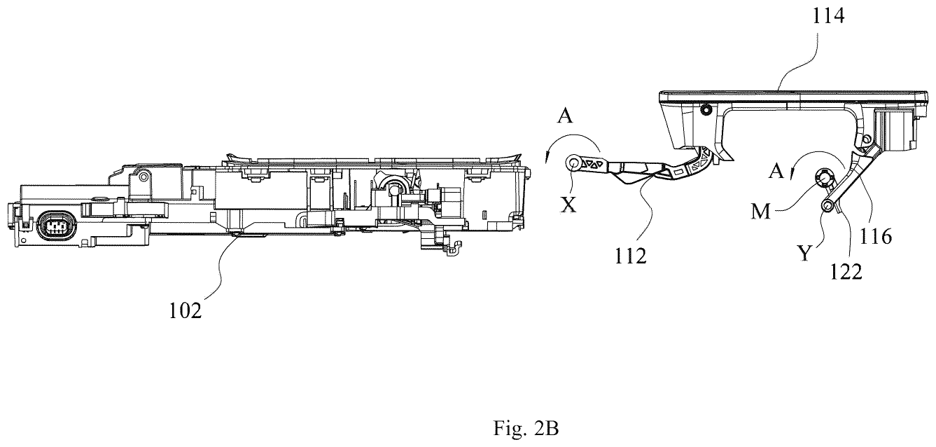

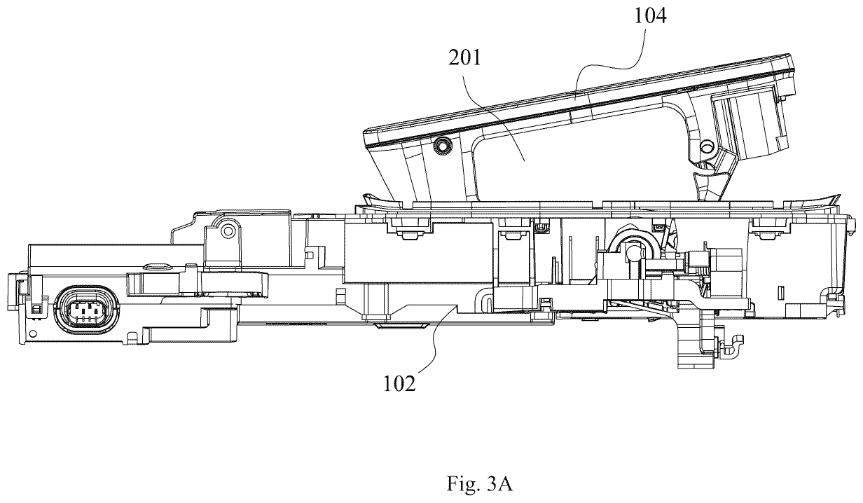

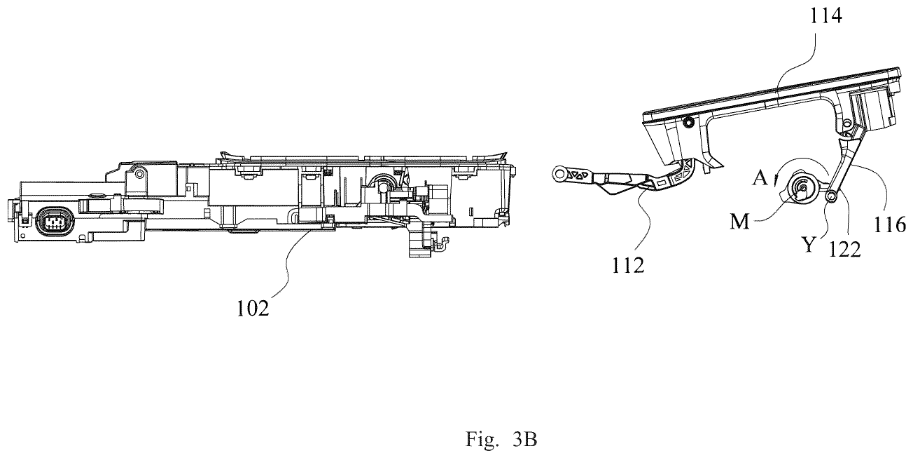

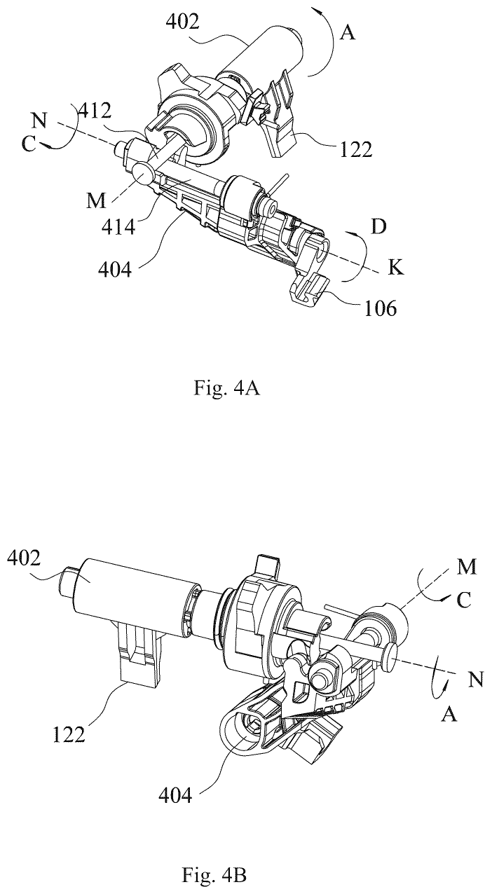

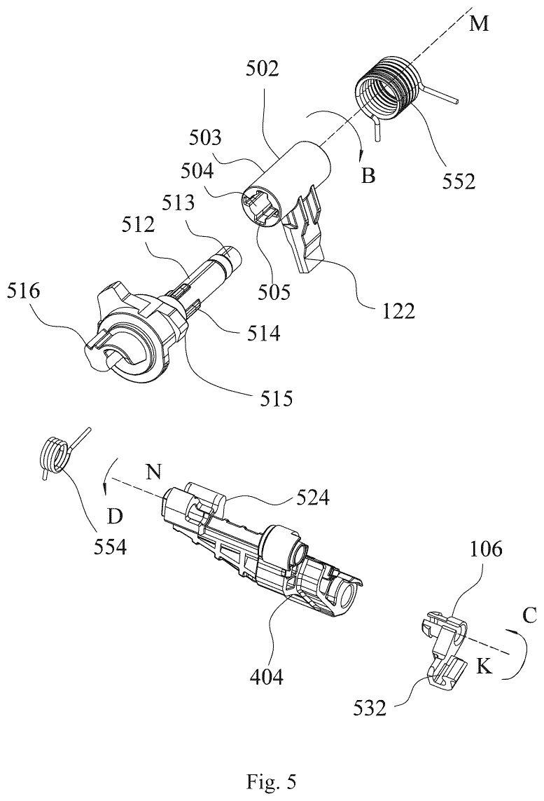

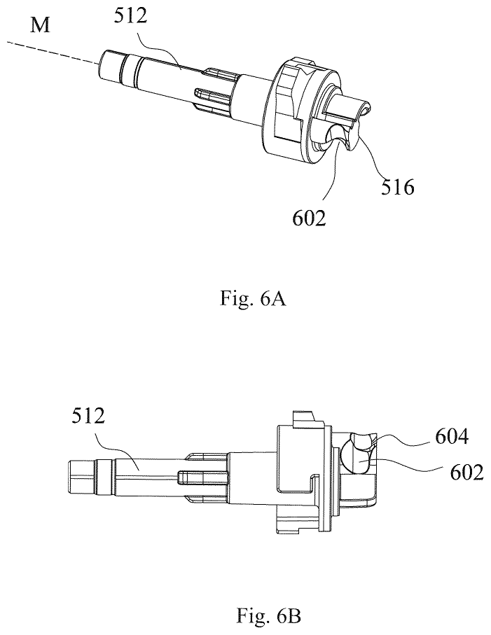

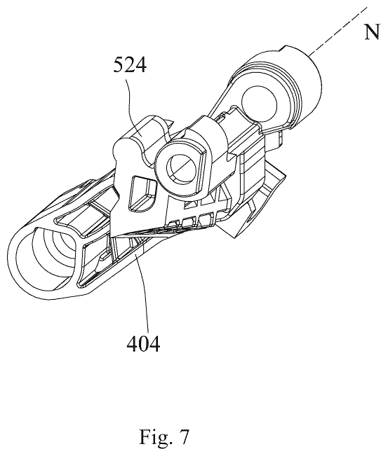

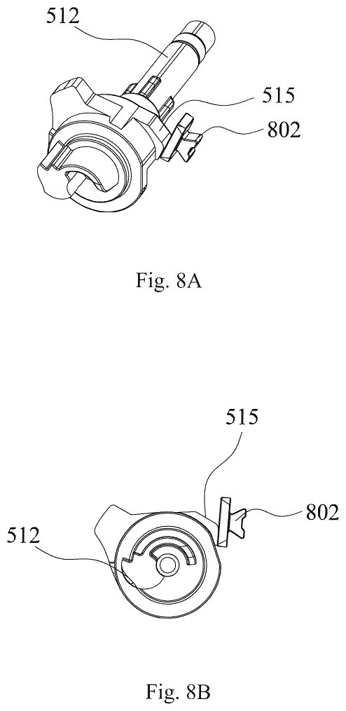

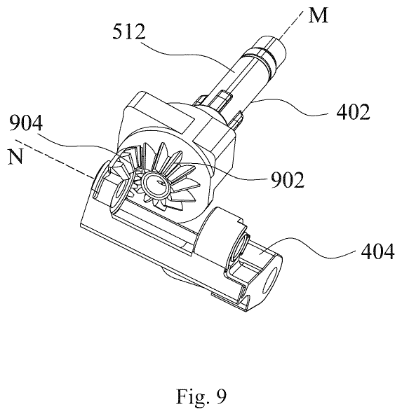

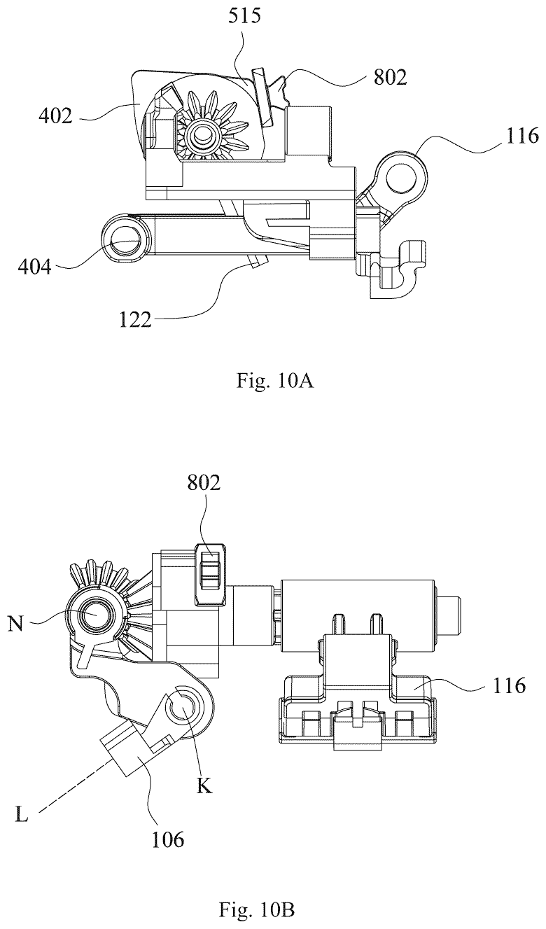

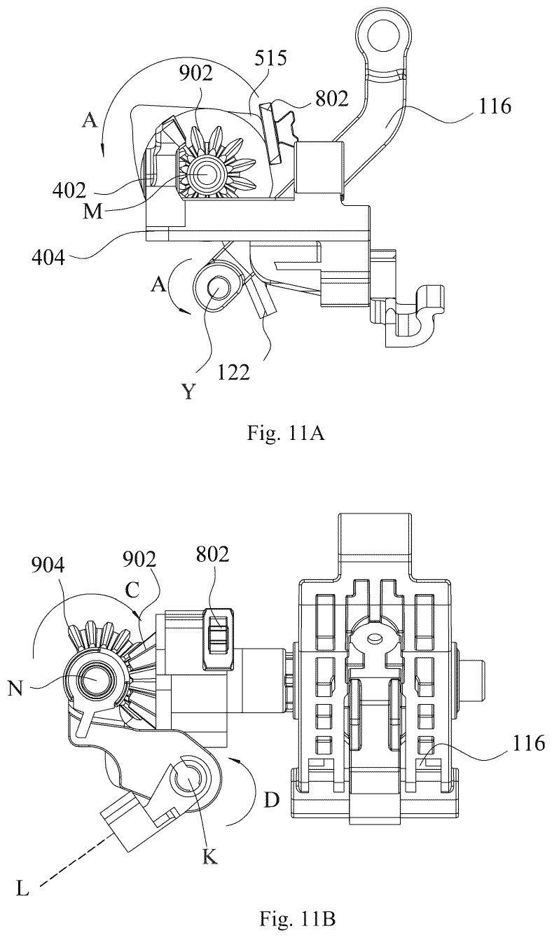

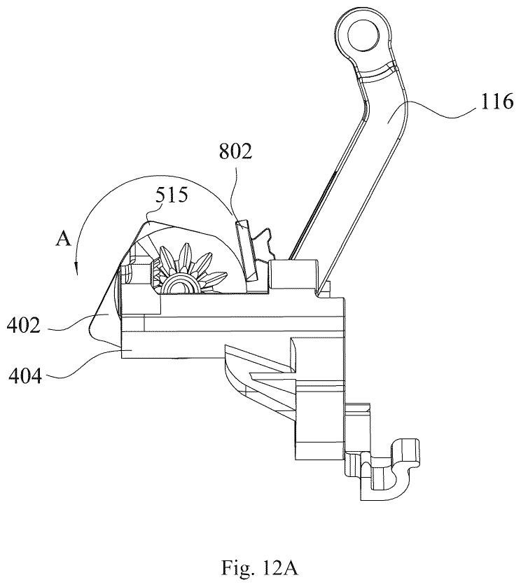

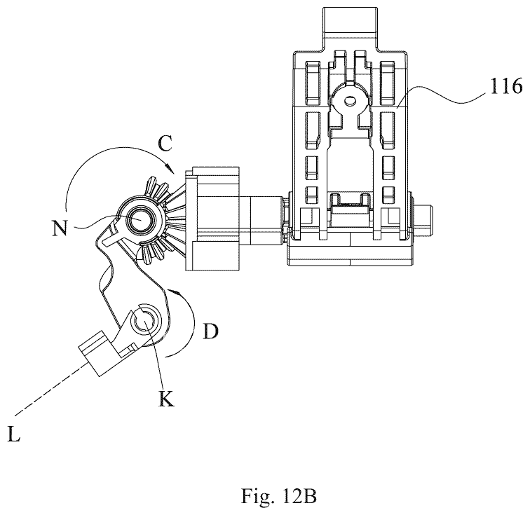

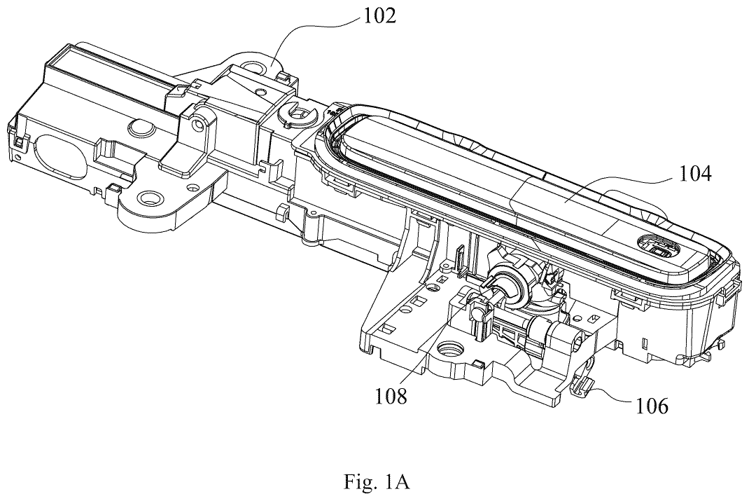

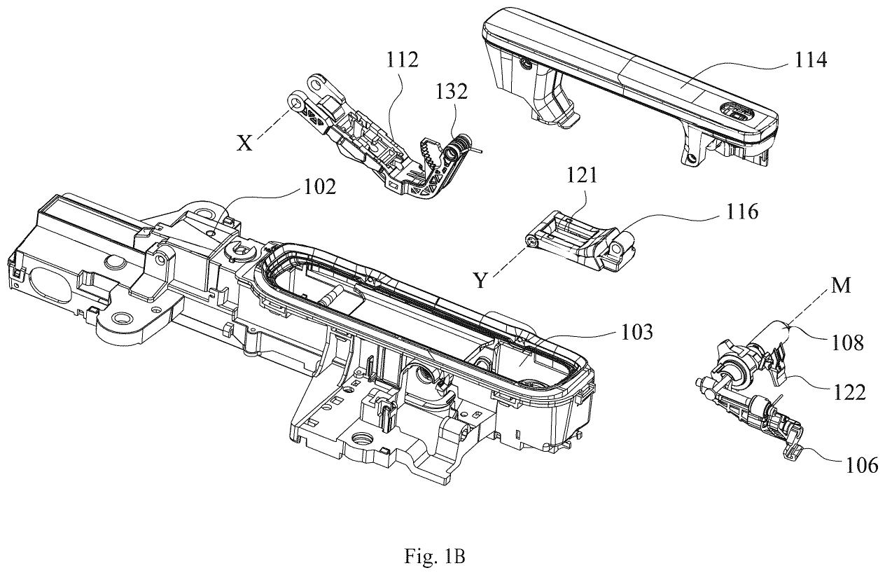

FIG. 1A is a perspective view of a door handle assembly of the present disclosure, and FIG. 1B is a partially exploded view of the door handle assembly of the present disclosure, with a handle 104 in a hidden position. As shown in FIGS. 1A-1B, the door handle assembly includes a base 102, the handle 104, a door lock lever driving component 106, and a transmission assembly 108. The base 102 defines a receiving space 103. The handle 104 can be received in the receiving space 103 and can move relative to the base 102. The handle 104 has the hidden position, an extended position, and a pulled position, and can be moved between the hidden position, the extended position, and the pulled position. When the handle 104 is in the hidden position, the handle 104 is located in the receiving space 103 so that a user's hand cannot hold the handle 104. As an example, when the handle 104 is in the hidden position, an outer surface of the handle 104 is flush with outer sheet metal (not shown) of a vehicle. When the handle 104 is in the extended position, at least a part of the handle 104 exits the receiving space 103 and enables the user's hand to hold the handle 104. The user can pull the handle 104 (i.e., apply an external force on the handle 104) and pull the handle 104 from the extended position to the pulled position.

As shown in FIGS. 1A-1B, the transmission assembly 108 can rotate relative to the base 102. The door lock lever driving component 106 is connected to the transmission assembly 108, and has a locked position and an unlocked position. The door lock lever driving component 106 can move between the locked position and the unlocked position relative to the base 102, and the door lock lever driving component 106 can perform a linear motion (i.e., movement) relative to the base 102 between the locked position and the unlocked position. The door lock lever driving component 106 is connected to a door lock lever (not shown) which can lock or release a door lock (not shown). In this way, a movement of the handle 104 relative to the base 102 can drive the transmission assembly 108 to rotate relative to the base 102, to drive the door lock lever driving component 106 to move from the locked position to the unlocked position. More specifically, when the handle 104 is in the hidden position and in the extended position, the door lock lever driving component 106 is in the locked position. When the door lock lever driving component 106 is in the locked position, the door lock lever locks the door lock, thereby locking a door (not shown). When the handle 104 is in the pulled position, the door lock lever driving component 106 is in the unlocked position. When the door lock lever driving component 106 is in the unlocked position, the door lock lever is separated from the door lock, thereby unlocking the door.

As shown in FIG. 1B, the handle 104 includes a first arm 112, a handle body 114, and a second arm 116. The handle body 114 is substantially in an elongated shape, to be convenient for the user to hold. The first arm 112 and the second arm 116 are each rotatably connected to the base 102. The first arm 112 can rotate about a first arm axis X. The second arm 116 can rotate about a second arm axis Y. The first arm axis X and the second arm axis Y are arranged in parallel. The handle body 114 is rotatably connected to the first arm 112 and the second arm 116. The second arm 116 is provided with a driving aperture 121. The driving aperture 121 passes through the second arm 116 in a thickness direction thereof for receiving at least a part of the transmission assembly 108.

As shown in FIG. 1B, the transmission assembly 108 includes a transmission arm 122. The transmission arm 122 can rotate about a first axis M relative to the base 102. The first axis M and the first arm axis X are arranged in parallel. A part of the transmission arm 122 is received in the driving aperture 121. When the handle 104 is in the hidden position, the transmission arm 122 is separated from a wall of the driving aperture 121, so that the handle 104 is separated from the transmission assembly 108.

As shown in FIG. 1B, the door handle assembly further includes a handle return component 132. The handle return component 132 is configured to enable the handle 104 to be moved from the pulled position to the extended position. In an aspect of the present disclosure, the handle return component 132 is a torsion spring. One end of the torsion spring abuts against the first arm 112, and the other end of the torsion spring abuts against the base 102, such that the torsion spring is pretensioned during the movement of the handle 104 from the pulled position to the extended position, and that when the handle 104 is moved to the pulled position and the external force (the pulling of the user's hand) disappears, a pretension force of the torsion spring applies a force on the handle 104 to return the handle 104 from the pulled position to the extended position. It can be understood that the handle return component 132 may be other elastic components in other aspects.

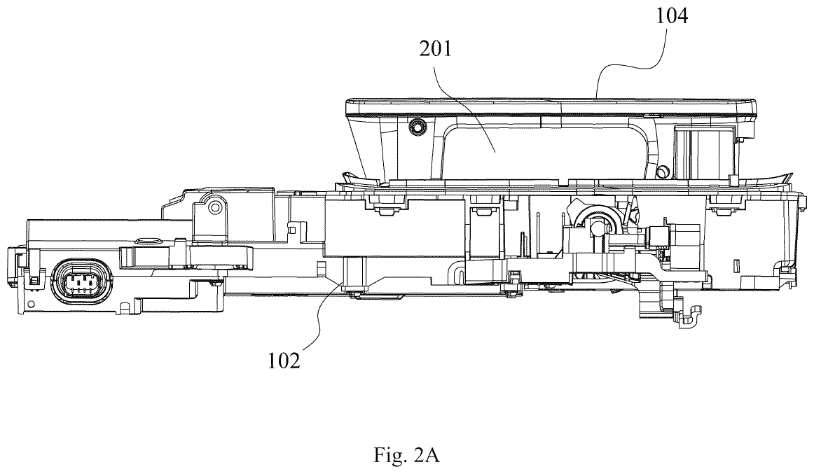

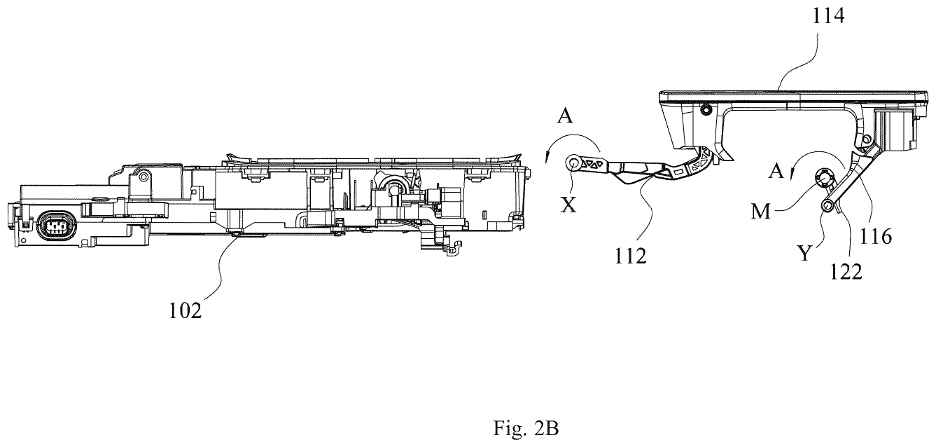

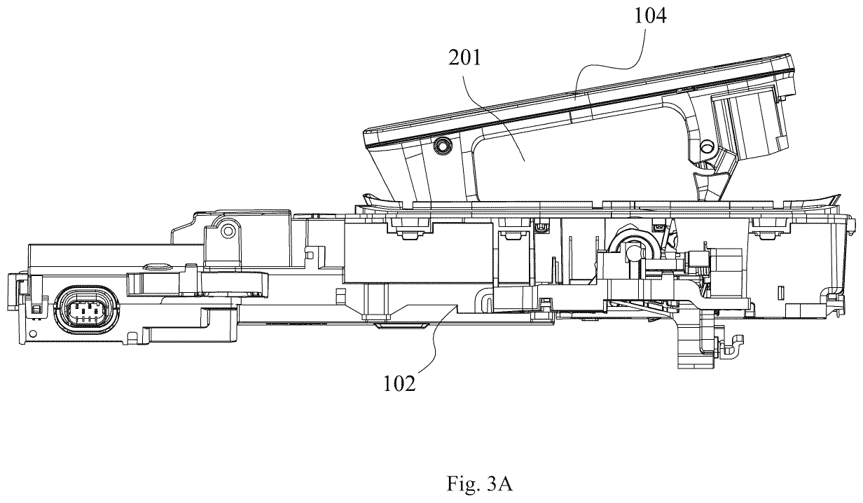

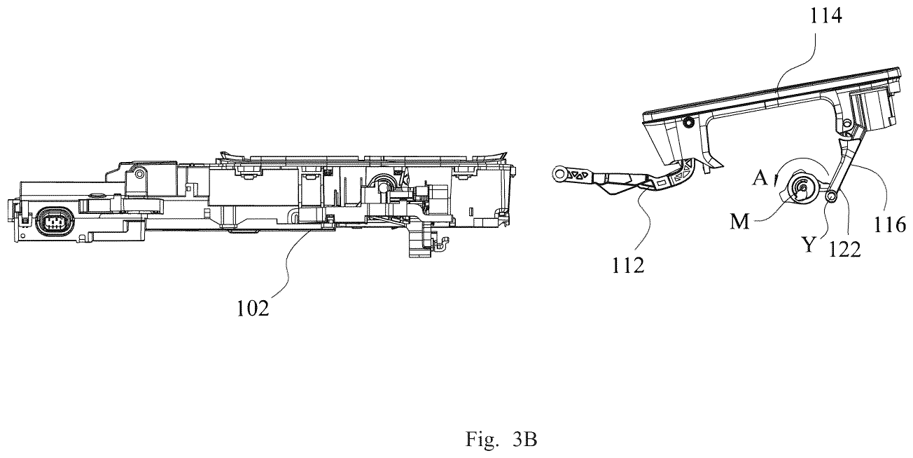

A mating relationship between the transmission arm 122 and the driving aperture 121 with the handle 104 in the extended position and in the pulled positions is described below with reference to FIGS. 2A-3B. For convenience of description, the direction of movement of the first arm 112 and the second arm 116 as the handle 104 moves from the hidden position to the extended position and then to the pulled position is referred to as a first direction A (as indicated by an arrow A in FIG. 2B).

FIG. 2A is a front view of the door handle assembly shown in FIG. 1A, and FIG. 2B is a partially exploded front view of the door handle assembly shown in FIG. 1A, with the handle 104 in the extended position. As shown in FIGS. 2A-2B, when the handle 104 is in the extended position, the handle body 114 exits the receiving space 103, such that a accommodating space 201 is formed between the handle body 114 and the base 102, so that the user's hand can reach into the accommodating space 201 and hold the handle body 114. A part of the transmission arm 122 is received in the driving aperture 121, and the transmission arm 122 is separated from the wall of the driving aperture 121, so that the handle 104 is separated from the transmission assembly 108.

As shown in FIGS. 1A-2B, a driving device (not shown) drives the first arm 112 or the second arm 116 to rotate in the first direction A relative to the base 102, to drive the handle 104 to move from the hidden position to the extended position. During the movement of the handle 104 from the hidden position to the extended position, the first arm 112 and the second arm 116 drive the handle body 114 to move substantially parallel to the base 102 away from the base 102. During the movement of the handle 104 from the hidden position to the extended position, the transmission arm 122 is always separated from the wall of the driving aperture 121, so that the handle 104 is always separated from the transmission assembly 108. In this way, during the movement of the handle 104 from the hidden position to the extended position, the movement of the handle 104 does not drive the transmission assembly 108 to move. Since the transmission assembly 108 remains stationary during the movement of the handle 104 from the hidden position to the extended position, the door lock lever driving component 106 also remains in the locked position at all times.

FIG. 3A is a front view of the door handle assembly shown in FIG. 1A, and FIG. 3B is a partially exploded front view of the door handle assembly shown in FIG. 1A, with the handle 104 in the pulled position. As shown in FIGS. 3A-3B, when the handle 104 is in the pulled position, comparing to the condition when the handle 104 is in the extended position, the second arm 116 is further away from the base 102. A part of the transmission arm 122 is received in the driving aperture 121 and abuts against the wall of the driving aperture 121, so that the handle 104 abuts against the transmission assembly 108. Comparing to the condition when the handle 104 is in the extended position, the transmission arm 122 is rotated further about the first axis M in the first direction A by an angle.

As shown in FIGS. 2A-3B, the user's hand pulls the handle body 114, to move the handle 104 from the extended position to the pulled position. During the movement of the handle 104 from the extended position to the pulled position, the second arm 116 rotates about the second arm axis Y in the first direction A relative to the base 102. The transmission arm 122 abuts against the wall of the driving aperture 121 such that the rotation of the second arm 116 about the second arm axis Y in the first direction A drives the transmission arm 122 to rotate about the first axis M in the first direction A. In this way, during the movement of the handle 104 from the extended position to the pulled position, the movement of the handle 104 drives the transmission assembly 108 to rotate. During the movement of the handle 104 from the extended position to the pulled position, the transmission assembly 108 drives the door lock lever driving component 106 to move from the locked position to the unlocked position.

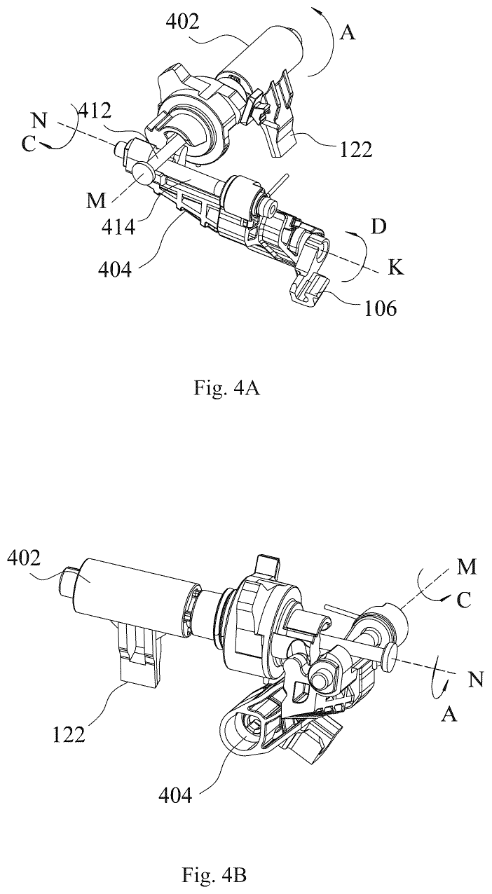

FIGS. 4A-4B are perspective views from different directions of a first aspect of the transmission assembly 108 and the door lock lever driving component 106. As shown in FIGS. 4A-4B, the transmission assembly 108 includes a first rotating assembly 402 and a second rotating component 404. The first rotating assembly 402 rotates about the first axis M relative to the base 102. The second rotating component 404 rotates about a second axis N relative to the base 102. The first axis M is substantially perpendicular to the second axis N. Specifically, the base 102 includes a first shaft 412 and a second shaft 414. The first shaft 412 defines the first axis M and extends through the first rotating assembly 402. The second shaft 414 defines the second axis N and extends through the second rotating component 404. The movement of the handle 104 can drive the first rotating assembly 402 to rotate about the first axis M in the first direction A, and the rotation of the first rotating assembly 402 about the first axis M in the first direction A can drive the second rotating component 404 to rotate about the second axis N in a third direction C (as shown by an arrow C in FIG. 4A).

As shown in FIGS. 4A-4B, the door lock lever driving component 106 is rotatably connected to the second rotating component 404. Specifically, the door lock lever driving component 106 can rotate about a third axis K relative to the second rotating component 404. The third axis K and the second axis N are arranged parallel to each other and offset by a distance. The rotation of the second rotating component 404 about the second axis N in the third direction C can drive the door lock lever driving component 106 to rotate about the third axis K in a fourth direction D (as shown by an arrow D in FIG. 4A) opposite to the third direction C.

In the present disclosure, as shown in FIGS. 4A-4B, during the movement of the handle 104 from the hidden position through the extended position to the pulled position, the first rotating assembly 402 rotates about the first axis M in the first direction A, to drive the second rotating component 404 to rotate about the second axis N in the third direction C, and the door lock lever driving component 106 to rotate about the third axis K in the fourth direction D.

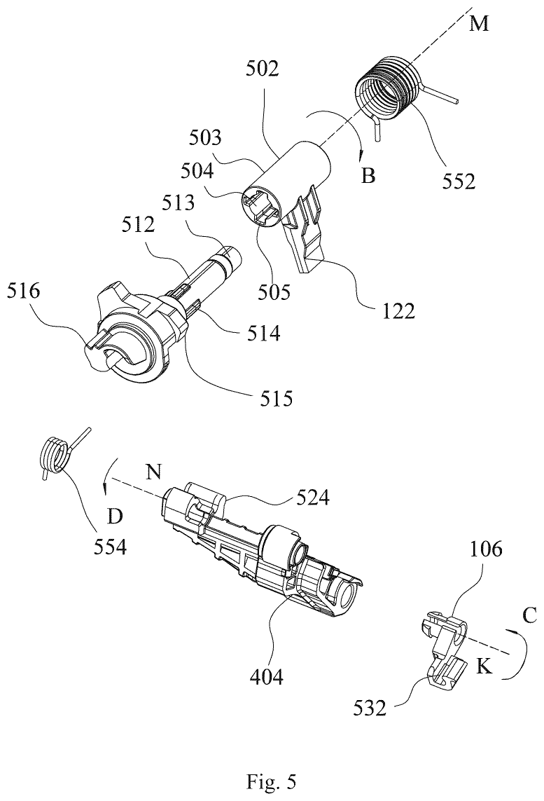

FIG. 5 is an exploded view of the first aspect of the transmission assembly 108 and the door lock lever driving component 106 shown in FIGS. 4A-4B. As shown in FIG. 5, the first rotating assembly 402 includes a sleeve member 502 and an insertion member 512. Specifically, the sleeve member 502 includes a sleeve body 503 and the transmission arm 122. The sleeve body 503 is substantially tubular and defines a body cavity 504. The body cavity 504 is recessed inwardly from an end face of the sleeve body 503 and extended in circumferential direction about the first axis M. The sleeve body 503 is further provided with four additional recesses 505. The four additional recesses 505 are in communication with the body cavity 504, are uniformly arranged in a circumferential direction of the body cavity 504, and are further recessed outwardly from a circumferential wall of the body cavity 504. The transmission arm 122 is connected to the sleeve member 502, and is formed by extending outwardly from an outer peripheral surface of the sleeve member 502. The insertion member 512 includes an insertion body 513 and four additional insertion portions 514. The insertion body 513 is substantially cylindrical. The four additional insertion portions 514 are uniformly distributed on an outer peripheral surface of the insertion body 513 and are formed by extending outwardly from the outer peripheral surface of the insertion body 513. The insertion body 513 is arranged in correspondence with the body cavity 504, and the four additional insertion portions 514 are arranged in correspondence with the four additional recesses 505, so that a part of the insertion member 512 can be inserted into the sleeve member 502, to connect the sleeve member 502 and the insertion member 512, and when the sleeve member 502 rotates about the first axis M, the insertion member 512 can rotate with the sleeve member 502. In other aspects of the present disclosure, the sleeve member 502 and the insertion member 512 may be integrally formed.

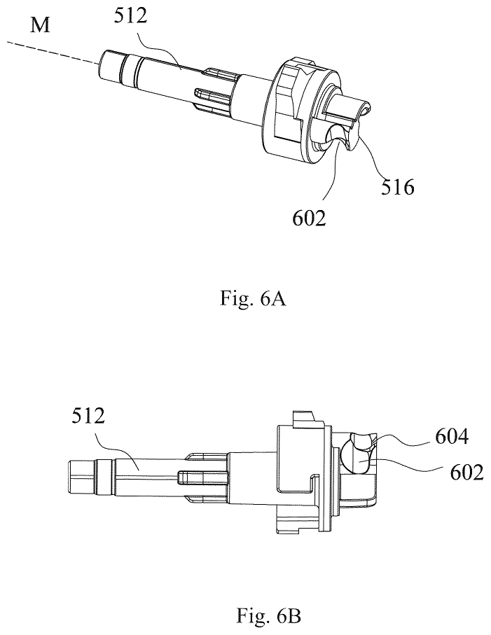

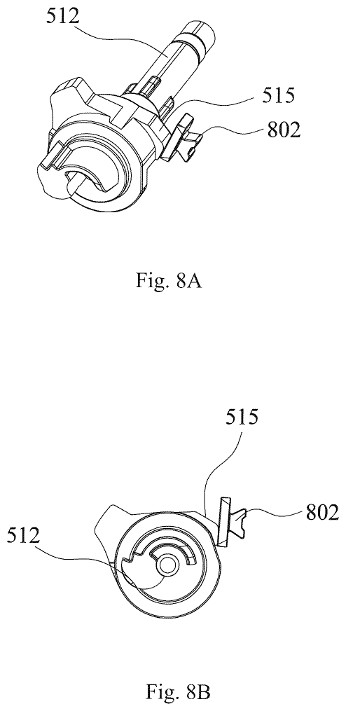

As shown in FIG. 5, the insertion member 512 further includes a limiting portion 515 and a first protrusion 516. The limiting portion 515 is formed by extending outwardly from the outer peripheral surface of the insertion body 513. The limiting portion 515 is configured to mate with an abutment member 802 (see FIGS. 8A-8B) provided on the base 102. The first protrusion 516 is formed by extending outwardly from the outer peripheral surface of the insertion body 513. The limiting portion 515 and the first protrusion 516 are spaced by a distance along the first axis M. In a direction along the first axis M, the limiting portion 515 is arranged between the first protrusion 516 and the additional insertion portions 514. The first protrusion 516 is provided with a guide recess 602 (see FIG. 6A) for mating with the second rotating component 404.

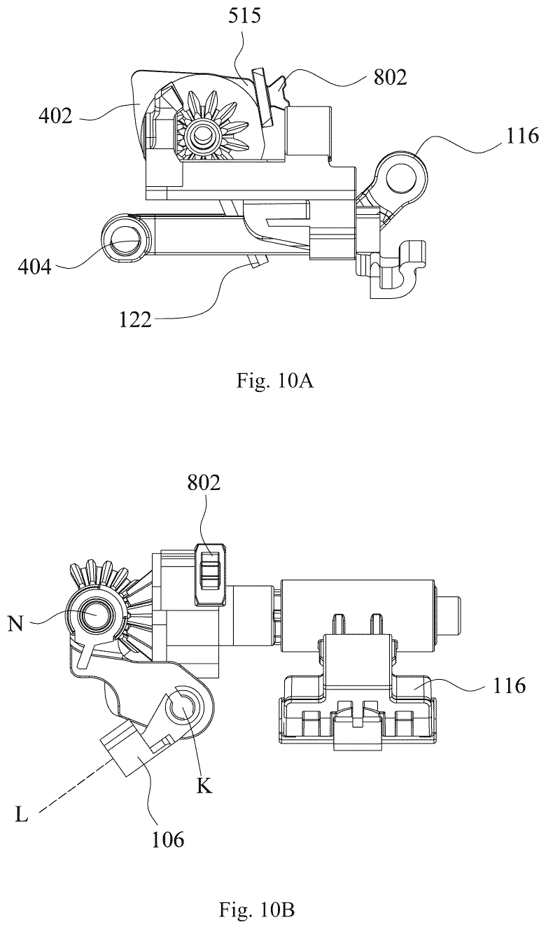

As shown in FIG. 5, the second rotating component 404 is provided with a guide protrusion 524 for mating with the guide recess 602 (see FIG. 6A) of the first protrusion 516. The door lock lever driving component 106 is rotatably connected to the second rotating component 404, and the door lock lever driving component 106 and the guide protrusion 524 are substantially located at two opposite ends of the second rotating component 404. The door lock lever driving component 106 is provided with a groove 532. The groove 532 is configured to receive a door lock lever (not shown). The door lock lever is a lever made of a hard material. When a door lock (not shown) has been installed, the relative position of the door lock lever relative to the base 102 is fixed. In other words, the door lock lever can only be moved along a predetermined path L (e.g., in a length direction L of the door lock lever, see FIGS. 10B and 11B) to unlock or lock the door lock. When the door lock lever is arranged in the groove 532, the position of the door lock lever relative to the door lock lever driving component 106 is fixed. When the first rotating assembly 402 rotates about the first axis M in the first direction A (see FIGS. 4A-4B) to drive the second rotating component 404 to rotate about the second axis N in the third direction C (see FIGS. 4A-4B) relative to the base 102, the door lock lever driving component 106 rotates about the third axis K in the fourth direction D relative to the second rotating component 404, so that the door lock lever moves along the predetermined path L to unlock.

The door handle assembly further include a transmission return assembly, as shown in FIG. 5. The transmission return assembly is configured to rotate the transmission assembly 108 during the movement of the handle from the pulled position to the extended position, to drive the door lock lever driving component 106 to move from the unlocked position to the locked position. In an aspect of the present disclosure, the transmission return assembly includes a first elastic member 552 and a second elastic member 554. The first elastic member 552 is configured to apply a force on the first rotating assembly 402 such that the first rotating assembly 402 rotates about the first axis M in a second direction B opposite to the first direction A. Specifically, during the movement of the handle 104 from the pulled position to the extended position, the first elastic member 552 is pretensioned, and after the handle 104 is moved to the pulled position and the external force (the pulling of the user's hand) disappears, the pretension force of the first elastic member 552 applies a force on the first rotating assembly 402 such that the first rotating assembly 402 rotates about the first axis M in the second direction B opposite to the first direction A. Similarly, the second elastic member 554 is configured to apply a force on the second rotating component 404 such that the second rotating component 404 rotates about the second axis N in the fourth direction D, and that the second rotating component 404 drives the door lock lever driving component 106 to move from the unlocked position to the locked position. Specifically, during the movement of the handle 104 from the pulled position to the extended position, the first rotating assembly 402 drives the second rotating component 404 to rotate such that the second elastic member 554 is pretensioned, and after the handle 104 is moved to the pulled position and the external force (the pulling of the user's hand) disappears, a pretension force of the second elastic member 554 applies a force on the second rotating component 404 such that the second rotating component 404 rotates about the second axis N in the fourth direction D. Since the door lock lever (not shown) can only move relative to the base 102 along the predetermined path L, the door lock lever driving component 106 rotates about the third axis K in the third direction C relative to the second rotating component 404, to move the door lock lever driving component 106 from the unlocked position to the locked position.

In an aspect of the present disclosure, the first elastic member 552 and the second elastic member 554 are torsion springs. It can be understood that in other aspects, the transmission return assembly may include other elastic components.

FIG. 6A is a perspective view of the insertion member 512 as shown in FIG. 5, and FIG. 6B is a side view of the insertion member as shown in FIG. 6A. As shown in FIGS. 6A-6B, the guide recess 602 is provided on the first protrusion 516. The guide recess 602 is arranged substantially in a circumferential direction about the first axis M. The guide recess 602 is configured to receive at least a part of the guide protrusion 524. The guide recess 602 is further configured such that during the movement of the handle 104 from the extended position to the pulled position, the guide recess 602 gradually moves away from the insertion member 512 in the direction of rotation about the first axis M in the first direction A.

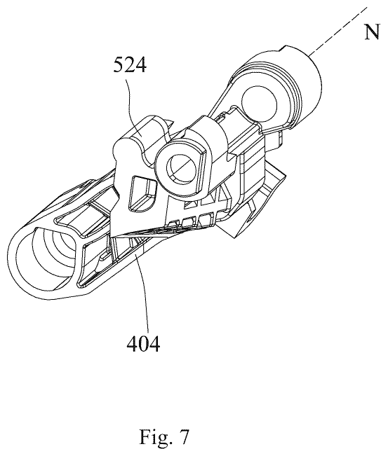

FIG. 7 is a perspective view of the second rotating component 404 as shown in FIG. 5. As shown in FIG. 7, the guide protrusion 524 is provided on the second rotating component 404 and extends a distance along the second axis N. In this way, when the insertion member 512 rotates about first axis M in the first direction A, the insertion member 512 can urge the second rotating component 404 to rotate about second axis N in the third direction C.

FIG. 8A is a perspective view showing the assembly of the insertion member 512 and the abutment member 802, and FIG. 8B is a front view showing the assembly of the insertion member 512 and the abutment member 802. The door handle assembly of the present disclosure further includes the abutment member 802. The abutment member 802 is arranged on the base 102 for interfacing with the limiting portion 515 of the first rotating assembly 402. Specifically, the limiting portion 515 is configured such that when the handle 104 is in the hidden position, the abutment member 802 abuts against the limiting portion 515 of the first rotating assembly 402 such that the handle 104 is maintained in the hidden position after being moved from the extended position to the hidden position. The abutment member 802 is made of a flexible material (e.g., rubber), thereby preventing the sound from generating as the abutment member 802 abuts against the limiting portion 515.

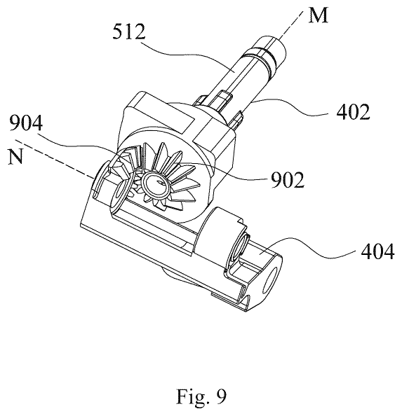

FIG. 9 is a perspective view of a second aspect of the transmission assembly 108 of the present disclosure. The similarities between the aspect shown in FIG. 9 and the aspect shown in FIGS. 4A-4B are not described further, and the main difference is that the first rotating assembly 402 in the aspect shown in FIGS. 4A-4B drives the second rotating component 404 to rotate by means of a recess and protrusion structure (i.e., the guide recess 602 and the guide protrusion 524), whereas the first rotating assembly 402 in FIG. 9 drives the second rotating component 404 to rotate by means of a gear structure. Specifically, an end portion of the insertion member 512 of the first rotating assembly 402 is provided with a first gear 902. The second rotating component 404 is provided with a second gear 904. The first gear 902 meshes with the second gear 904 such that the rotation of the first rotating assembly 402 about the first axis M drives the second rotating component 404 to rotate about the second axis N. In the present disclosure, the first gear 902 and the second gear 904 are both external gears.

It can be understood by those skilled in the art that while the present disclosure shows two specific aspects of the transmission assembly 108, any aspect in which the rotation of the first rotating assembly 402 around the first axis M can drive the second rotating component 404 to rotate about the second axis N is within the scope of protection of the present disclosure.

FIG. 10A is a front view of the transmission assembly 108 as shown in FIG. 9, the second arm 116 of the handle 104, the abutment member 802, and the door lock lever driving component 106, and FIG. 10B is a side view of the transmission assembly 108 as shown in FIG. 9, the second arm 116 of the handle 104, the abutment member 802, and the door lock lever driving component 106, with the handle 104 in the hidden position and the door lock lever driving component 106 in the locked position. As shown in FIGS. 10A-10B, when the handle 104 is in the hidden position and the door lock lever driving component 106 is in the locked position, the limiting portion 515 abuts against the abutment member 802, and the door lock lever driving component 106 defines a direction of extension of the door lock lever (not shown) as a predetermined direction L. With reference to FIG. 1B, the transmission arm 122 is located in the driving aperture 121 and is separated from the wall of the driving aperture 121 in this case.

FIG. 11A is a front view of the transmission assembly 108 as shown in FIG. 9, the second arm 116 of the handle 104, the abutment member 802, and the door lock lever driving component 106, and FIG. 11B is a side view of the transmission assembly 108 as shown in FIG. 9, the second arm 116 of the handle 104, the abutment member 802, and the door lock lever driving component 106, with the handle 104 in the extended position and the door lock lever driving component 106 in the locked position. As shown in FIGS. 11A-11B, when the handle 104 is in the extended position and the door lock lever driving component 106 is in the locked position, with reference to FIGS. 2A-2B, the transmission arm 122 is located in the driving aperture 121 and is separated from the wall of the driving aperture 121 in this case. In this way, during the movement of the handle 104 from the hidden position to the extended position, the movement of the handle 104 does not drive the transmission assembly 108 to move. The door lock lever driving component 106 is therefore always in the locked position.

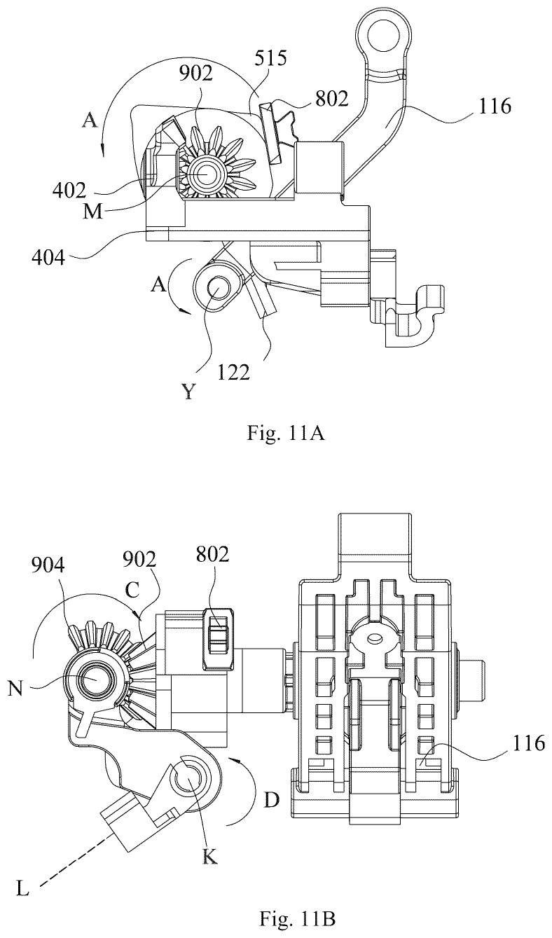

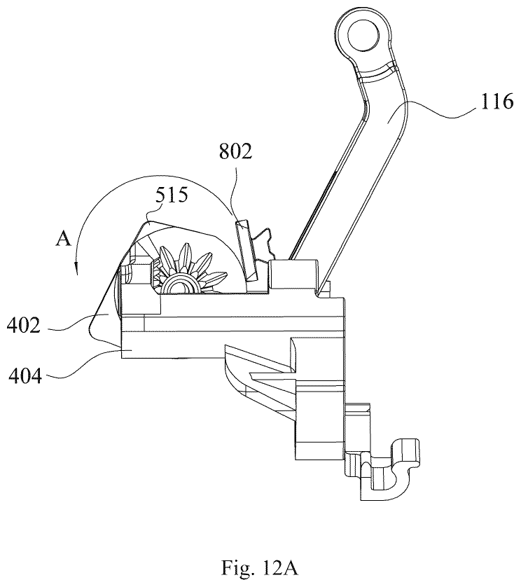

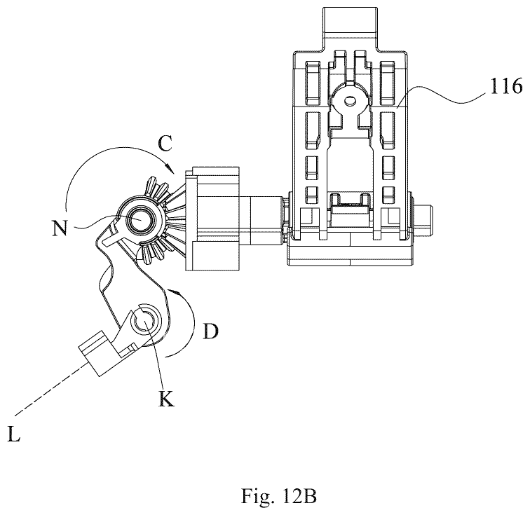

FIG. 12A is a front view of the transmission assembly 108 as shown in FIG. 9, the second arm 116 of the handle 104, the abutment member 802, and the door lock lever driving component 106, and FIG. 12B is a side view of the transmission assembly 108 as shown in FIG. 9, the second arm 116 of the handle 104, the abutment member 802, and the door lock lever driving component 106, with the handle 104 in the pulled position and the door lock lever driving component 106 in the unlocked position. As shown in FIGS. 11A-11B, when the handle 104 is in the pulled position and the door lock lever driving component 106 is in the unlocked position, the transmission arm 122 is located in the driving aperture 121 and abuts against the wall of the driving aperture 121, and the limiting portion 515 is separated from the abutment member 802. Compared to the positions of the components where the handle 104 is in the extended position and the door lock lever driving component 106 is in the locked position, the first rotating assembly 402 is rotated about the first axis M in the first direction A by an angle relative to the base 102, the second rotating component 404 is rotated about the second axis N in the third direction C by an angle relative to the base 102, and the door lock lever driving component 106 is rotated about the third axis K in the fourth direction D by an angle relative to the second rotating component 404. The door lock lever driving component 106 still defines the direction of extension of the door lock lever (not shown) as the predetermined direction L.

How the movement of the second arm 116 of the handle 104 from the extended position to the pulled position drives the door lock lever driving component 106 to move from the locked position to the unlocked position is described below with reference to FIGS. 11A-12B.

As shown in FIGS. 11A-12B, during the movement of the handle 104 from the hidden position through the extended position to the pulled position, the rotation of the second arm 116 of the handle 104 about the second arm axis Y in the first direction A relative to the base 102 drives the transmission arm 122 of the first rotating assembly 402 to rotate about the first axis M in the first direction A relative to the base 102, to separate the limiting portion 515 from the abutment member 802. The first gear 902 of the first rotating assembly 402 meshes with the second gear 904 of the second rotating component 404 such that the rotation of the first rotating assembly 402 about the first axis M in the first direction A drives the second rotating component 404 to rotate about the second axis N in the third direction C. Since the door lock lever (not shown) defines the predetermined direction L, when the second rotating component 404 rotates about the second axis N in the third direction C, the door lock lever driving component 106 rotates about the third axis K in the fourth direction D relative to the second rotating component 404 due to the limiting of the door lock lever, so that the door lock lever driving component 106 is moved from the locked position to the unlocked position.

When the door is unlocked, the human hand releases the handle 104 and the handle 104 is moved from the pulled position to the extended position under the action of the handle return component 132. The transmission arm 122 is separated from the wall of the driving aperture 121, so that the handle 104 is separated from the transmission assembly 108. The first rotating assembly 402 rotates about the first axis M in the second direction B under the action of the first elastic member 552, and the second rotating component 404 rotates about the second axis N in the fourth direction D under the action of the second elastic member 554, to drive the door lock lever driving component 106 to rotate about the third axis K in the third direction C, to move from the unlocked position to the locked position, until the limiting portion 515 abuts against the abutment member 802 again, the handle 104 returns to the extended position and the door lock lever driving component 106 returns to the locked position.

The inventors of the present disclosure have found that in the prior art, a movement travel (movement path) and a direction of movement of a door lock cable are variable because the door lock cable is made of a flexible material.

The door handle assembly of the present disclosure is suitable for a door lock lever made of a hard material (e.g., metal, or plastic), has a simple structure and an invariable movement, and can drive the door lock lever driving component to move between the locked position and the unlocked position, thereby enabling locking and unlocking of a door lock.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A door handle assembly, comprising:
a base, the base defining a receiving space;
a handle, the handle being arranged in the receiving space and movable relative to the base;
a transmission assembly, the transmission assembly being rotatable relative to the base; and
a door lock lever driving component, the door lock lever driving component being connected to the transmission assembly and having a locked position and an unlocked position, and the door lock lever driving component being movable relative to the base between the locked position and the unlocked position,
wherein a movement of the handle relative to the base is capable of driving the transmission assembly to rotate relative to the base, to drive the door lock lever driving component to move from the locked position to the unlocked position.

2. The door handle assembly of claim 1, wherein
the handle has an extended position and a pulled position and is movable between the extended position and the pulled position,
wherein a movement of the handle from the extended position to the pulled position is capable of driving the transmission assembly to rotate, to drive the door lock lever driving component to move from the locked position to the unlocked position.

3. The door handle assembly of claim 2, wherein
the handle further has a hidden position and is movable between the hidden position and the extended position; and
during a movement of the handle from the hidden position to the extended position, the handle is separated from the transmission assembly such that the movement of the handle does not drive the door lock lever driving component to move.

4. The door handle assembly of claim 3, wherein the transmission assembly comprises:
a first rotating assembly, the first rotating assembly being rotatable about a first axis relative to the base; and
a second rotating component, the second rotating component being rotatable about a second axis relative to the base, and the door lock lever driving component being rotatably connected to the second rotating component;
wherein the handle is capable of driving the first rotating assembly to rotate, and the first rotating assembly is capable of driving the second rotating component to rotate.

5. The door handle assembly of claim 4, wherein
the first axis is substantially perpendicular to the second axis.

6. The door handle assembly of claim 4, wherein
the door lock lever driving component is rotatable about a third axis relative to the second rotating component to move relative to the base; and
the second axis and the third axis are arranged parallel to each other and offset by a distance.

7. The door handle assembly of claim 4, wherein
the handle is provided with a driving aperture, the first rotating assembly comprises a transmission arm, and at least a part of the transmission arm is received in the driving aperture; and
the transmission arm is separated from a wall of the driving aperture during the movement of the handle from the hidden position to the extended position, and the handle drives the transmission arm during the movement of the handle from the extended position to the pulled position.

8. The door handle assembly of claim 7, wherein the handle further comprises:
a first arm, the first arm being rotatably connected to the base;
a second arm, the second arm being rotatably connected to the base; and
a handle body, the handle body being rotatably connected to the first arm and the second arm,
wherein the second arm is provided with the driving aperture, and
wherein during the movement of the handle from the extended position to the pulled position, the transmission arm abuts against the second arm, to drive the transmission arm.

9. The door handle assembly of claim 4, wherein
the first rotating assembly is provided with a guide recess, and the second rotating component is provided with a guide protrusion, wherein the guide protrusion is capable of being at least partially received in the guide recess; and
the guide recess and the guide protrusion are configured such that rotation of the first rotating assembly about the first axis is capable of driving the second rotating component to rotate about the second axis.

10. The door handle assembly of claim 9, wherein
the guide recess is arranged about the first axis and is recessed inwardly from an outer surface of the first rotating assembly; and
the guide protrusion is formed by extending a distance along the second axis.

11. The door handle assembly of claim 4, further comprising:
an abutment member, wherein the abutment member is arranged on the base, and the first rotating assembly is provided with a limiting portion; and
the limiting portion is configured such that when the handle is in the hidden position, the abutment member abuts against the first rotating assembly such that the handle is maintained in the hidden position after being moved from the extended position to the hidden position.

12. The door handle assembly of claim 4, wherein
the abutment member is made of a flexible material.

13. The door handle assembly of claim 4, wherein
the first rotating assembly is provided with a first gear, the second rotating component is provided with a second gear, and the first gear and the second gear mesh with each other such that rotation of the first rotating assembly about the first axis is capable of driving the second rotating component to rotate about the second axis.

14. The door handle assembly of claim 6, further comprising:
a transmission return assembly configured to rotate the transmission assembly during a movement of the handle from the pulled position to the extended position, to drive the door lock lever driving component to move from the unlocked position to the locked position.

15. The door handle assembly of claim 4, wherein the transmission return assembly comprises:
a first elastic member, the first elastic member being configured to apply a force on the first rotating assembly such that the first rotating assembly rotates about the first axis; and
a second elastic member, the second elastic member being configured to apply a force on the second rotating component such that the second rotating component rotates about the second axis.

16. The door handle assembly of claim 3, further comprising:
a handle return component, the handle return component being configured to apply a force on the handle, to move the handle from the pulled position to the extended position.
